(19) United States
(12) Patent Application Publication
(10) Pub. No.: US 2025/0300911 A1
(43) Pub. Date: Sep. 25, 2025

(54) Optimizing Processor Unit Frequency

(71) Applicant: Rakuten Symphony, Inc., Tokyo (JP)

(72) Inventors: Sree Nandan Atur, Newark, CA (US); Ravi Kumar Alluboyina, Santa Clara, CA (US)

(21) Appl. No.: 18/006,982

(22) PCT Filed: Dec. 16, 2022
(86) PCT No.: PCT/US2022/053186

§ 371 Date: Jan. 26, 2023

(51) Int. Cl. H04L 43/026; G06N 3/0442; G06N 3/08

(52) U.S. Cl. CPC H04L 43/026; G06N 3/0442; G06N 3/08

(57) ABSTRACT

The present invention extends to methods, systems, and computer program products for optimizing processor core frequency in view of predicted network traffic patterns. Network packets defining a network traffic flow can be received at a platform over time. Metrics can be derived from one or more applications executing at one or more processing units of the platform and processing data contained in the network data packets. Model training data can be formulated from the metrics. A processor unit frequency adjustment model can be trained using the model training data. Executing the model can be automated to adjust the frequency of a processing unit from among the one or more processing units. Additional network packets defining an additional network traffic flow can be received at a platform over time. Data contained in the additional network packets can be processed at the processing unit at the adjusted frequency.

### CROSS-REFERENCE TO RELATED APPLICATIONS

Not applicable.

### BACKGROUND

### 1. Field of the Invention

This invention relates generally to the field of computing, and, more particularly, to optimizing processing unit frequency in view of predicted network traffic patterns.

### 2. Related Art

In network systems, there is typically no power management at the computer system (server) level. Processors (e.g., CPUs) run at a default frequency virtually all of the time. In some environments, running a processor at a default frequency results in inefficient power usage and/or increased packet drops over time.

For example, data intensive and network intensive applications running on a (e.g., Kubernetes) cluster can be affined to isolated cores respecting a Non-Uniform Memory Access (NUMA) boundary. The amount of work done by these applications is directly proportional to the amount of data or network packets processed. The amount of data or network packets processed is in turn directly proportional to a processor core frequency. Further, processor core frequency is directly proportion to wattage (power consumed). Running a processor at a higher core frequency consumes more power.

When an amount of data or network packets is insufficient to fully utilize a processor operating at a particular frequency, the processor has at least some idle time resulting inefficient power usage. When an amount of data or network packets is too much for a processor operating at a particular frequency, data and/or network packets can be dropped resulting in retransmission or potential data loss.

Some threshold-based approaches utilize manually configured thresholds/rules to adjust processor frequency under various conditions.

### BRIEF DESCRIPTION OF THE DRAWINGS

The specific features, aspects and advantages of the present invention will become better understood with regard to the following description and accompanying drawings where:

FIG. 1 illustrates an example architecture that facilitates optimizing processor unit frequency.

FIG. 2 illustrates a flow chart of an example method for optimizing processor unit frequency.

FIG. 3 illustrates an example traffic flow relative to processing unit frequency.

FIG. 4 illustrates an example block diagram of a computing device.

### DETAILED DESCRIPTION

The present invention extends to methods, systems, and computer program products for optimizing processor core frequency in view of predicted network traffic patterns.

When a processor unit runs at a higher (or its highest frequency), corresponding applications can deliver more (or maximum) work. However, the data volume may be low enough that all data is processable at a frequency lower than the higher (or highest) frequency. If the processor unit is nonetheless run at the higher (or highest) frequency, power resources can be underutilized (or wasted).

When a processor unit runs at lower frequency power can be conserved. However, the data volume may be too high for the processor unit to handle all of the data. If the processor unit is nonetheless run at the lower frequency data can be lost (e.g., packets can be dropped).

A processor unit may also be run at a median frequency. If a processor unit is run at a median frequency, power resources can be underutilized (or wasted) and/or data can be lost (e.g., packets can be dropped) over time as data volume changes.

Aspects of the invention can predict processor unit workload over time and adjust processor unit frequency to deliver a larger amount of work while consuming less power. Processing unit frequency (and thus power consumption) can be adjusted (e.g., increased or decreased) based on (e.g., network) traffic flow patterns to mitigate packet drops for applications.

Network traffic can be predicted based on past learnings and processor unit frequency can be adjusted ahead of time. Processing unit frequency can be optimized to network traffic patterns. Network traffic patterns can be predicted based on historical Key Performance Indicators (KPIs), trends, metrics, etc. with enough probability to optimize processing unit frequencies.

As such, potential processing issues (e.g., inefficient power usage, packet drops, etc.) can be predicted prior to occurring. In response to predicting a processing issue, a processing unit frequency is adjusted (e.g., increased or decreased) based on the historical Key Performance Indicators (KPIs), trends, metrics, etc. Adjustments can take corrective actions in terms of: optimal usage of power resources, scaling application instances, healing application instances (e.g., with migration/relocation), upgrading applications, etc.

In one aspect, a Recurrent Neural Network (RNN), such as, a Long Short-Term Memory (LTSM) model, can be used to predict future network traffic patterns based on prior network traffic patterns. Processing unit frequency can be adjusted (e.g., increased or decreased) to adapt to predicted traffic patterns.

In this description and the following claims, a “processing unit” is defined as electronic circuitry that executes instructions of a computer program. A processing unit can be a central processing unit (CPU), a Graphical Processing Units (GPUs), a general-purpose GPUs (GPGPUs), a Field Programmable Gate Arrays (FPGA), an application specific integrated circuits (ASICs), a Tensor Processing Units (TPUs), etc. Processing unit is also defined to include a core of a multi-core processor.

In this description and the following claims, a “multi-core processor” is defined as a microprocessor on a single integrated circuit with two or more separate processing units, called cores, each of which reads and executes program instructions. The instructions are ordinary CPU instructions (such as add, move data, and branch) but the single processor can run instructions on separate cores at the same time, increasing overall speed for programs that support multithreading or other parallel computing techniques.

In this description and the following claims, “Non-Uniform Memory Access (NUMA)” is a computer memory design used in multiprocessing where memory access time depends on memory location relative to a processor. Under NUMA, a processor can access its own local memory and storage faster than non-local memory and storage (i.e., memory/storage local to another processor or memory/storage shared between processors). A NUMA architecture can include one or more “nodes” of resources. The resources at a NUMA node can include a plurality of CPUs connected to volatile memory and connected to one or more Non-Volatile Memory Express (NVMe) (or other) storage devices.

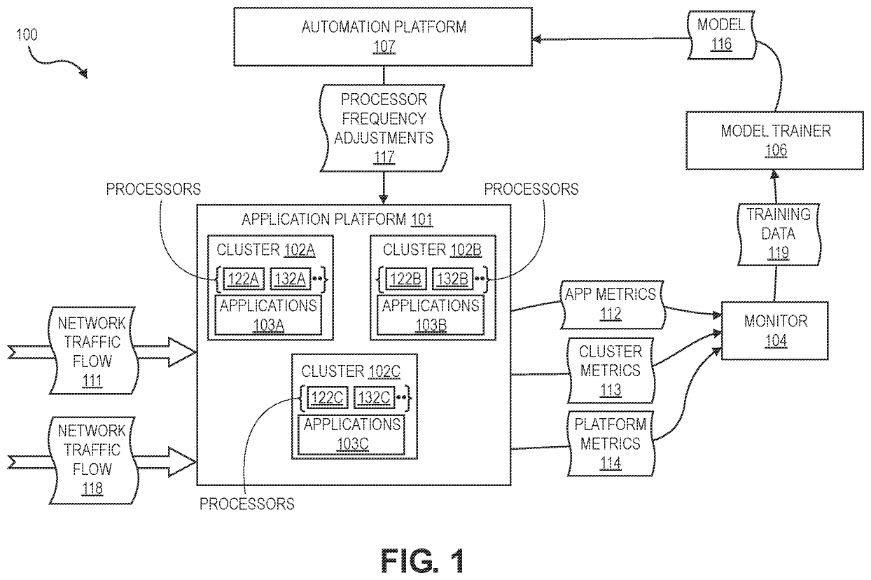

FIG. 1 illustrates an example architecture 100 that facilitates optimizing processor unit frequency. As depicted, architecture 100 includes application platform 101, monitor 104, model trainer 106, and automation platform 107. Application platform 101 further includes clusters 102A, 102B, and 102C. Cluster 102A includes processor units 122A, 132A, etc. and applications 103A (running on the processors). Cluster 102B includes processor units 122B, 132B, etc. and applications 103B (running on the processors). Cluster 102C includes processor units 122C, 132C, etc. and applications 103C (running on the processors). It may be that each of clusters 102A, 102B, and 102C is a different NUMA node.

In general, application platform 101 can receive a plurality of network packets over time defining an existing network traffic flow. Applications at application platform 101 can run on corresponding cluster processors. For example, applications 103A can run on processors 122A, 132A, etc. Similarly, applications 103B can run on processors 122B, 132B, etc. Likewise, applications 103C can run on processors 122C, 132C, etc.

Applications 103A, 103B, 103C, can process data contained in the network packets. The speed an application can process data depends on the frequency of the processor unit where the application is running. An application can process data faster when running on a processing unit operating at a higher frequency. On the other hand, an application processes data slower when running on a processing unit operating at a lower frequency.

Over time, monitor 104 can monitor application platform 101, clusters 102A, 102B, and 102C, and applications 103A, 103B, and 103C. Monitor 104 can collect metrics associated with any of: application platform 101, clusters 102A, 102B, and 102C, and applications 103A, 103B, and 103C during processing of data contained in network packets by any of: applications 103A, 103B, and 103C. Monitor 104 can derive training data from the collected metrics. The derived training data can be used to train processor unit frequency adjustment models. Monitor 104 can send the derived training data to model trainer 106.

Model trainer 106 can receive training data from monitor 104. Model trainer 106 can train processor unit frequency adjustment models using the training data. Processor unit frequency adjustment models can be RNNs such at LTSM models. Model trainer 106 can send processor unit frequency adjustment models to automation platform 107.

A model can be configured to implement various conditions:
Case 1: 0% packet drops
   Mitigate packet drop independent of incoming network traffic rate
Case 2: Minimal acceptable packet drops based on processing unit temperature
   Depending on processing unit operating temperature, there can be scenarios where packet drops are acceptable. Packet drops can be minimized as much as possible while keeping processing unit temperature below a maximum allowable temperature (e.g., 100° C.)
Case 3: x % power savings
   It's not necessary user wants to achieve highest power savings because sometimes cost for x % power savings (e.g., 25%) is the same as cost for y % power savings (e.g., 30%)
Case 4: Latency requirements defines critical RT, non-critical RT deployment
   Inference latency
   Metrics interval period

Automation platform 107 can receive processor unit frequency adjustment models from model trainer 106. Automation platform 107 can execute a processor frequency adjustment model to predict network packets defining further network traffic flow patterns to be received at application platform 101. Based on predicted further network traffic flow patterns, automation platform 107 can send processor frequency adjustments to application platform 101. The processor frequency adjustments can include instructions to adjust (e.g., increase or decrease) the frequency of any of: processor units 122A, 132A, etc., processor units 122B, 132B, etc., or processor units 122C, 132C, etc.

Application platform 101 can receive processor frequency adjustments from automation platform 107. Application platform 101 can adjust the frequency at any of: processor units 122A, 132A, etc., processor units 122B, 132B, etc., or processor units 122C, 132C, etc. in accordance with instructions included in received processor frequency adjustments. Adjusting processor unit frequency can optimize the processor unit frequency for processing data in network packets of the further network flow.

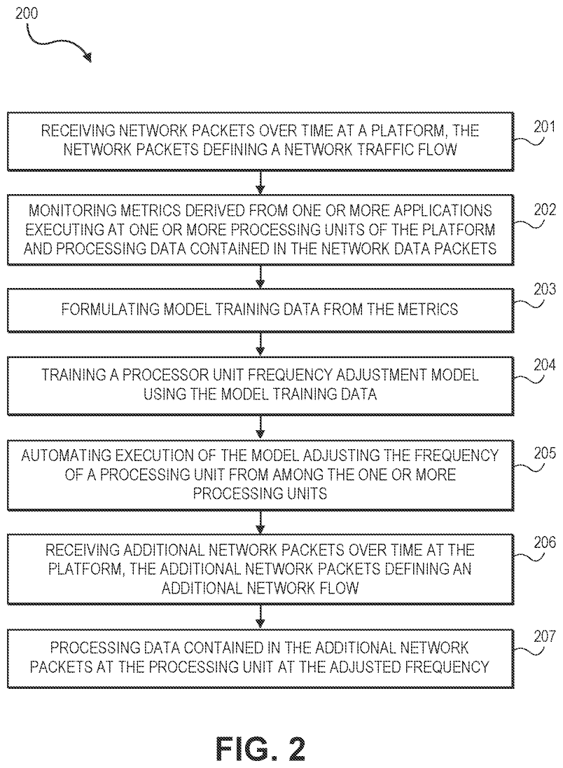

FIG. 2 illustrates a flow chart of an example method 200 for optimizing processor unit frequency. Method 200 will be described with respect to the components and data in architecture 100.

Method 200 includes receiving network packets over time at a platform, the network packets defining a traffic network flow (201). For example, application platform 101 can receive a plurality of network packets over time defining network traffic flow 111. Applications at application platform 101 can run on corresponding processors and can process data contain in the network packets of network traffic data flow 111. For example, an application 103A can run on processor 132A to process data contained in the network packets of network traffic data flow 111. Similarly, an application 103C can run on processor 122C to process data contained in the network packets of network traffic data flow 111.

Method 200 includes monitoring metrics derived from one or more applications executing at one or more processing units of the platform and processing data contained in the network data packets (202). For example, monitor 104 can monitor app metrics 112, cluster metrics 113, and platform metrics 114 derived from applications 103A executing on processors 122A, 132A, etc., from applications 103B executing on processors 122B, 132B, etc., and from applications 103C executing on processors 122C, 132C, etc. Applications 103A, 103B, and 103C can process data contained in network packets of network traffic flow 111. App metrics 112 can be metrics corresponding to applications 103A, 130B, and 103C. Cluster metrics 113 can be metrics corresponding to clusters 102A, 102B, and 102C. Platform metrics 114 can correspond to application platform 101.

Method 200 includes formulating model training data from the metrics (203). For example, monitor 104 can formulate training data 119 from app metrics 112, cluster metrics 113, and platform metrics 114. Monitor 104 can send training data 119 to model trainer 106. Model trainer 106 can receive training data 119 from monitor 104. Method 200 includes training a processor unit frequency adjustment model using the model training data (204). For example, model trainer 106 can train model 116 using training data 119. Model 116 can be an RNN, such as, as an LTSM model, configured to predict subsequent network traffic flows received at application platform 101. Model trainer 106 can send model 116 to automation platform 107. Automation platform 107 can receive model 116 from model trainer 106.

Method 200 includes automating execution of the model adjusting the frequency of a processing unit from among the one or more processing units (205). For example, automation platform 107 can automate execution of model 116. Executing model 116 can predict network packets defining network traffic flow 118 are to be received at application platform 101. Based on predicting network traffic flow 118, automation platform 107 can derive processor frequency adjustments 117. Automation platform 107 can send processor frequency adjustments 117 to application platform 101.

Application platform 101 can adjust the frequency of one or more of: processors 122A, 132A, etc., processors 122B, 132B, etc., or processors 122C, 132C, etc. in accordance with processor frequency adjustments 117. Processor frequencies can be adjusted in anticipation of receiving the network packets defining network traffic flow 118. Adjusting processor frequencies can optimize the processor frequencies for processing the network packets defining network traffic flow 118. For example, one or more processor frequencies can be decreased if the workload associated with network traffic flow 118 is anticipated to be less than the workload associated with network traffic flow 111. One the other hand, one or more process frequencies can be increased if the workload associated with network traffic flow 118 is anticipated to be more than the workload associated with network traffic flow 111.

Method 200 includes receiving additional network packets at the platform, the additional network packets define an additional network flow overtime (206). For example, subsequent to receiving network packets defining network traffic flow 111, application platform 101 can receive additional network packets defining network traffic flow 118.

Method 200 includes processing data contained in the additional network packets at the processing unit at the adjusted frequency (207). For example, one or more of processors 122A, 132A, etc., processors 122B, 132B, etc., or processors 122C, 132C, etc. can process data contained in network packets of network traffic flow 118 at frequencies previously adjusted in accordance with processor frequency adjustments 117. Processing data at the adjusted frequencies optimizes data processing by providing sufficient processing resources in a manner that also minimizes power consumption.

Method 200 or portions thereof can be repeated responsive to processing data packets in network traffic flow 118 to further refine a frequency adjustment model configured to adjust processor frequencies at application platform 101.

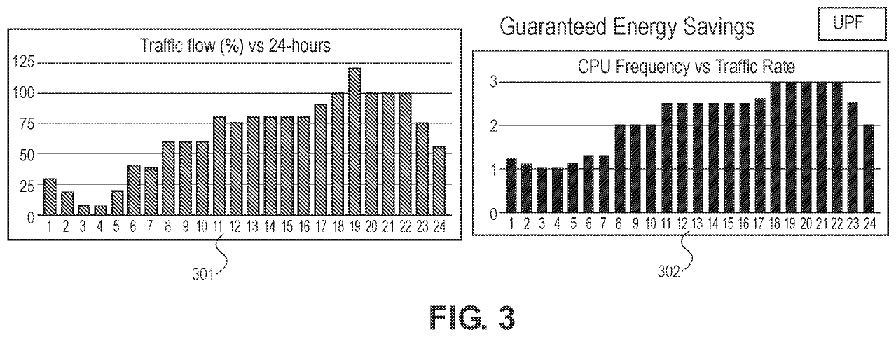

FIG. 3 illustrates an example network traffic flow 301 relative to processing unit frequency 302. As depicted, processor unit frequency 302 is adjusted to match network traffic flow 301 as the network traffic flow changes over time. For example, processor frequency is reduced at hours 3 and 4 to reduce power consumption in view of reduced traffic flow. On the other hand, processor frequency is increased to a highest frequency at hours 18, 19, 20, 21, and 22 to provide increased processing resources in view of increased traffic flow.

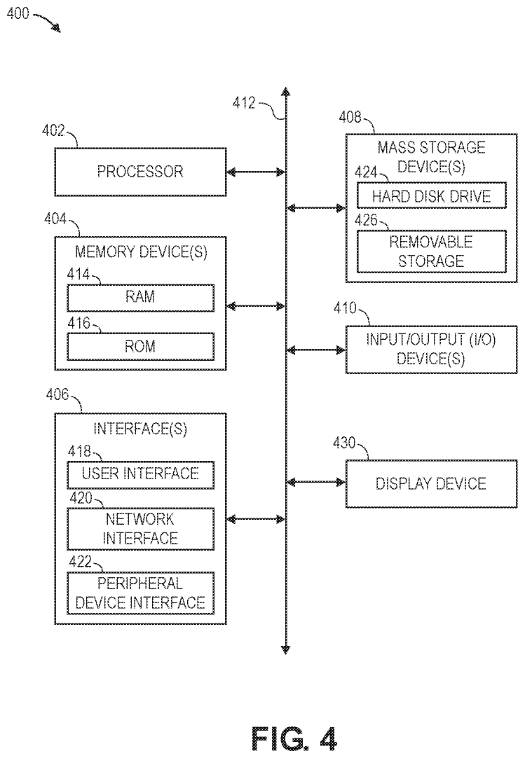

FIG. 4 illustrates an example block diagram of a computing device 400. Computing device 400 can be used to perform various procedures, such as those discussed herein. Computing device 400 can function as a server, a client, or any other computing entity. Computing device 400 can perform various communication and data transfer functions as described herein and can execute one or more application programs, such as the application programs described herein. Computing device 400 can be any of a wide variety of computing devices, such as a mobile telephone or other mobile device, a desktop computer, a notebook computer, a server computer, a handheld computer, tablet computer and the like.

Computing device 400 includes one or more processor(s) 402, one or more memory device(s) 404, one or more interface(s) 406, one or more mass storage device(s) 408, one or more Input/Output (I/O) device(s) 410, and a display device 430 all of which are coupled to a bus 412. Processor(s) 402 include one or more processors or controllers that execute instructions stored in memory device(s) 404 and/or mass storage device(s) 408. Processor(s) 402 may also include various types of computer storage media, such as cache memory.

Memory device(s) 404 include various computer storage media, such as volatile memory (e.g., random access memory (RAM) 414) and/or nonvolatile memory (e.g., read-only memory (ROM) 416). Memory device(s) 404 may also include rewritable ROM, such as Flash memory.

Mass storage device(s) 408 include various computer storage media, such as magnetic tapes, magnetic disks, optical disks, solid state memory (e.g., Flash memory), and so forth. As depicted in FIG. 4, a particular mass storage device is a hard disk drive 424. Various drives may also be included in mass storage device(s) 408 to enable reading from and/or writing to the various computer readable media. Mass storage device(s) 408 include removable media 426 and/or non-removable media.

I/O device(s) 410 include various devices that allow data and/or other information to be input to or retrieved from computing device 400. Example I/O device(s) 410 include cursor control devices, keyboards, keypads, barcode scanners, microphones, monitors or other display devices, speakers, printers, network interface cards, modems, cameras, lenses, radars, CCDs or other image capture devices, and the like.

Display device 430 includes any type of device capable of displaying information to one or more users of computing device 400. Examples of display device 430 include a monitor, display terminal, video projection device, and the like.

Interface(s) 406 include various interfaces that allow computing device 400 to interact with other systems, devices, or computing environments as well as humans. Example interface(s) 406 can include any number of different network interfaces 420, such as interfaces to personal area networks (PANs), local area networks (LANs), wide area networks (WANs), wireless networks (e.g., near field communication (NFC), Bluetooth, Wi-Fi, etc., networks), and the Internet. Other interfaces include user interface 418 and peripheral device interface 422.

Bus 412 allows processor(s) 402, memory device(s) 404, interface(s) 406, mass storage device(s) 408, and I/O device(s) 410 to communicate with one another, as well as other devices or components coupled to bus 412. Bus 412 represents one or more of several types of bus structures, such as a system bus, PCI bus, IEEE 1394 bus, USB bus, and so forth.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can transform information between different formats, such as, for example, network packets, network traffic flows, app metrics, cluster metrics, platform metrics, training data, models, processor frequency adjustments, etc.

System memory can be coupled to the one or more processors and can store instructions (e.g., computer-readable instructions, computer-executable instructions, etc.) executed by the one or more processors. The system memory can also be configured to store any of a plurality of other types of data generated by the described components, such as, for example, network packets, network traffic flows, app metrics, cluster metrics, platform metrics, training data, models, processor frequency adjustments, etc.

Aspects of the invention can facilitate significant power savings (e.g., reducing power consumption by 30% to 40%). During prolonged off-peak hours workload relocation can optimize power savings even further. Using less power along with reduced operational expenses translates to financial savings. Aspects of the invention also (potentially significantly) reduce application downtime translating to higher availability and improved customer experience.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations can comprise or utilize a special purpose or general-purpose computer including computer hardware, such as, for example, one or more computer and/or hardware processors (including any of Central Processing Units (CPUs), and/or Graphical Processing Units (GPUs), general-purpose GPUs (GPGPUs), Field Programmable Gate Arrays (FPGAs), application specific integrated circuits (ASICs), Tensor Processing Units (TPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash or other vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications, variations, and combinations are possible in light of the above teaching. Further, it should be noted that any or all of the aforementioned alternate implementations may be used in any combination desired to form additional hybrid implementations of the disclosure.

What is claimed:

1. A computer implemented method comprising:
receiving network packets over time at a platform, the network packets defining a network traffic flow;
monitoring metrics derived from one or more applications executing at one or more processing units of the platform and processing data contained in the network data packets;
formulating model training data from the metrics;
training a processor unit frequency adjustment model using the model training data;
automating execution of the model adjusting the frequency of a processing unit from among the one or more processing units;
receiving additional network packets over time at the platform, the additional network packets defining an additional network flow; and
processing data contained in the additional network packets at the processing unit at the adjusted frequency.

2. The method of claim 1, wherein training a processor unit frequency adjustment model comprises training a Recurrent Neural Network (RNN).

3. The method of claim 1, wherein training a processor unit frequency adjustment model comprises training an Long Short-Term Memory (LTSM) model.

4. The method of claim 1, wherein automating execution of the model comprises executing the model to predict an increase in network traffic.

5. The method of claim 4, wherein adjusting the frequency of a processing unit comprises increasing the frequency of the processing unit.

6. The method of claim 1, wherein automating execution of the model comprises executing the model to predict a decrease in network traffic.

7. The method of claim 6, wherein adjusting the frequency of a processing unit comprises decreasing the frequency of the processing unit.

8. The method of claim 1, wherein adjusting the frequency of a processing unit from among the one or more processing units comprises optimizing the frequency of the processing unit to provide sufficient processor resources to process data contained in the additional network packets without inappropriately consuming power.

9. A computer system comprising:
a processor;
system memory coupled to the processor and storing instructions configured to cause the processor to:
receive network packets over time at a platform, the network packets defining a network traffic flow;
monitor metrics derived from one or more applications executing at one or more processing units of the platform and processing data contained in the network data packets;
formulate model training data from the metrics;
train a processor unit frequency adjustment model using the model training data;
automate execution of the model adjusting the frequency of a processing unit from among the one or more processing units;
receive additional network packets over time at the platform, the additional network packets defining an additional network flow; and
process data contained in the additional network packets at the processing unit at the adjusted frequency.

10. The computer system of claim 9, wherein instructions configured to train a processor unit frequency adjustment model comprise instructions configured to train a Recurrent Neural Network (RNN).

11. The computer system of claim 9, wherein instructions configured to train a processor unit frequency adjustment model comprise instructions configured to train an Long Short-Term Memory (LTSM) model.

12. The computer system of claim 9, wherein instructions configured to automate execution of the model comprise instructions configured to execute the model to predict an increase in network traffic.

13. The computer system of claim 12, wherein instructions configured to adjust the frequency of a processing unit comprise instructions configured to increase the frequency of the processing unit.

14. The computer system of claim 9, wherein instructions configured to automating execution of the model comprises instructions configured to execute the model to predict a decrease in network traffic.

15. The computer system of claim 14, wherein instructions configured to adjust the frequency of a processing unit comprises wherein instructions configured to decrease the frequency of the processing unit.

16. The computer system of claim 9, wherein instructions configured to adjust the frequency of a processing unit from among the one or more processing units comprises wherein instructions configured to optimize the frequency of the processing unit to provide sufficient processor resources to process data contained in the additional network packets without inappropriately consuming power.
